(19) United States
(12) Patent Application Publication
(10) Pub. No.: US 2024/0161942 A1
(43) Pub. Date: May 16, 2024

(54) HORIZONTAL TO ON-EDGE TRANSITION MODULE CONFIGURATION IN ENERGY DISTRIBUTION LINES

(71) Applicant: EAE ELEKTRIK ASANSOR ENDUSTRISI INSAAT SANAYI VE TICARET ANONIM SIRKETI, Istanbul (TR)

(72) Inventor: Hidir GÖGÜLTER, Istanbul (TR)

(21) Appl. No.: 18/147,792

(22) Filed: Dec. 29, 2022

(30) Foreign Application Priority Data
Nov. 15, 2022 (TR) 2022017236

(51) Int. Cl. H01B 5/00

(52) U.S. Cl. CPC H01B 5/002

(57) ABSTRACT

A horizontal to on-edge transition module configuration which is created to be used in changes according to the way the line goes and the phase sequence in energy distribution lines, and whose electrical transition resistance is minimized.

### CROSS-REFERENCE TO RELATED APPLICATIONS

Not applicable

### FIELD AND BACKGROUND OF THE INVENTION

The invention relates to horizontal to on-edge transition module configuration in energy distribution lines.

In particular, the invention relates to the horizontal to on-edge transition module configuration, which is created to be used in changes according to the way the line goes and the phase sequence in energy distribution lines, and whose electrical transition resistance is minimized.

Today, modular compact conductors called busbars are used in energy distribution systems. Each conductor, called busbar, is more preferred because it has high current carrying properties.

Energy continuity is essential in a functioning energy distribution system. The mentioned busbar lines consist of more than one module. By adding these modules end-to-end, energy distribution line installation is carried out.

Electric distribution and transportation systems, known as busbars, have a modular structure. Each busbar module is added end-to-end according to the route of the electric line, forming the electric transmission line. Modules are connected to each other by means of apparatus called additional modules.

The busbar additional module connects the conductive bars in the busbar modules to each other electrically and mechanically and ensures the continuation of the line.

While the conductive bars in the aforementioned Busbar modules move horizontally, they must continue vertically under some conditions, depending on the state of the structure in which they are positioned. When such a situation occurs, it is more difficult to assemble Busbar conductor bars to each other.

It is far above the dimensions of the busbar used in current applications and is mounted with many bolt-nut connections. This situation both increases the losses and increases the voltage drop as the busbar axes are opened.

In the aforementioned systems, several step transitions are provided by making bolted connections and a minimum of 2 different transitions are made for a single conductor. The loosening of the bolts and their surface resistance greatly reduce the module efficiency. Since the phase axes are far from each other, it increases the voltage drop. The IP value of the mentioned systems is IP55.

Today, the shape of the plank, beam, lath, bar, etc. to be placed longitudinally, with their thickness in the direction of view and their width perpendicular to it, so that the loads and weights to be carried on their narrowest edges are called on-edge.

On the other hand, on-edge bending, which is one of the techniques used in the current technique, is basically used for bending materials. The materials suitable for on-edge bending are of rectangular cross section. Considering the neutral axis of these materials, it is easily understood which side can be bent more easily.

Less force is applied to make the correct bend from the neutral axis closer to the edge. In addition, more force is required to bend the edge away from the neutral axis.

The bending on-edge application can be done with the help of a hammer, as in different bending applications. However, twisting operations can also be done by machine or molds. When bending on-edge with a machine or a hammer, the section thickens on the bent side, while thinning occurs in the outer section.

In the patent application numbered TR 2014/03421 in the literature, “The invention is the conductive busbar used in the return modules of the modular busbar electrical distribution systems, and a monolithic flat conductive piece is used as a reference to a twisting point determined on the piece, in a twisting apparatus, using the bending on-edge technique. It is characterized by the fact that it is obtained as a result of bending.” statements are included.

In the mentioned application, the structuring of bending on-edge conductor busbars in energy transmission lines is disclosed.

Again in the literature, in the US patent application numbered US2009191739A1 on the subject, “A coupling assembly is provided for an electrical busway having a first section and a second section. The coupling assembly includes at least one housing having first and second ends. A plurality of electrical conductors extend through such housing and electrically connect the first and second sections of the electrical busway. A plurality of electrical insulators surround at least some of the electrical conductors. A first coupling member couples the first end of the at least one housing to the first section of the electrical busway, and a second coupling member couples the second end of such housing to the second section of the electrical busway. The at least one housing and the electrical conductors extending therethrough are flexible, and the housing is electrically grounded. The coupling assembly electrically connects the first and second sections of the electrical busway, without a number of separate termination boxes.” statements are included.

In said application, a coupling assembly is disclosed in an energy transmission busbar system, in which various parts are used to electrically interconnect.

Again in the literature, in the Utility model application numbered TR 2022/002048, regarding the subject, “The invention is to feed low voltage distribution networks and subscribers connected to this network, to preserve subscriber meters and to minimize illegal intervention, to prevent illegal electricity use, to transfer horizontal meter indices to the automation system. In the panel connections of electronic electricity meters to provide energy and communication connections with the help of pins and sockets on the busbar without using cables, the modular busbar system positioned on the panel floor sheet on which a horizontal electronic electricity meter can be mounted, the lower cover of the busbar entrance, where the connection of the modular busbar system with the mains is provided. With the help of R phase bus, S phase bus, T phase bus and neutral busbar, it distributes the current to be measured to the electronic electricity meters, and can be easily and permanently attached to the modular busbar system of the electronic electricity meter. To the meter connection sockets that allow the removal of electricity, the neutral busbars to the interconnection busbar that allows the neutral busbars to be used jointly for all electronic electricity meters, the busbar part that is used to distribute any of the R, S, T phases according to the demand, is closed to outside intervention, protected and providing work safety, The busbar meter module top cover, which reduces labor with ease of installation, includes GPRS, Lora, Ethernet, power line, etc. between electronic electricity meters. the RS485 pin socket that enables the use of modems that communicate with various technologies, the barriers on the lower part of the busbar counter module top cover, which prevents the structure of the busbar counter module from deteriorating as a result of the meter connection socket being opened excessively, It is related to the modular busbar system, which has feeders that increase the strength of the busbar counter module, and the tabs on the busbar counter module bottom cover, which allows the busbar meter module bottom covers to be expanded as much as desired.” statements are included.

In the aforementioned application, transition from horizontal to vertical is provided with a bolt-nut connection.

Due to the reasons mentioned above, there was a need to structuring of a new horizontal to on-edge transition module in energy distribution lines.

### SUMMARY OF THE INVENTION

Based on this position of the technique, the aim of the invention is to present a new horizontal to on-edge transition module configuration in energy distribution lines that eliminates the existing disadvantages.

Another aim of the invention is to present a structure that eliminates the problem of requiring assembly in the field.

Another aim of the invention is to present a structure that eliminates bolt-nut connection loosening situations.

Another aim of the invention is to present a structure that greatly reduces production costs.

Another aim of the invention is to present a structure in which the electrical transition resistance is minimum and thus the losses are minimized.

Another aim of the invention is to present a structure in which the voltage drop is minimized since the busbar axes will not be opened.

### BRIEF DESCRIPTION OF DRAWINGS

FIG. 1 is a representative view of the horizontal to on-edge transition module configuration, which is the subject of the invention.

FIG. 2 is another representative view of the horizontal to on-edge transition module configuration, which is the subject of the invention.

FIG. 3 is a representative view of the conductor bar from the top in the configuration of the horizontal to on-edge transition module, which is the subject of the invention.

FIG. 4 is a detailed perspective view of the conductor bar in the configuration of the horizontal to on-edge transition module, which is the subject of the invention.

### REFERENCE NUMBERS

A—Transition Module Configuration
1. Body Ground Connection Module
2. Body
3. Conductor Bar
3.1 Horizontal Conductor
3.2 Curved Corner
3.3 On-edge Conductor

### DETAILED DESCRIPTION OF THE INVENTION

At In this detailed explanation, the innovation that is the subject of the invention is only explained with examples that will not have any limiting effect for a better understanding of the subject.

The invention is horizontal to on-edge transition module configuration (A) made to be used in the energy distribution lines containing the conductor bar (3) that provides energy transmission and the body (2) that provides protection and continuity by holding together the said conductor bars (3), which the electrical transition resistance is minimized, which is created to be used in changes according to the way the line goes and the phase sequence characterized in that, comprises on-edge conductor (3.3), which is the section where the said conductor rods (3) move vertically with the transition from horizontal to vertical, curved corner (3.2), which enables said conductor bars (3) to transition from the horizontal conductor (3.1) state to the on-edge conductor (3.3) state, body ground connection module (1), which provides the transmission of the soil and protects the curved corner (3.2) and horizontal conductor (3.1) and the on-edge conductor (3.3) from external factors, by closing the entrance areas of the horizontal conductor (3.1) combined by the curved corner (3.2).

FIG. 1 shows a representative view of the horizontal to on-edge transition module configuration (A), which is the subject of the invention.

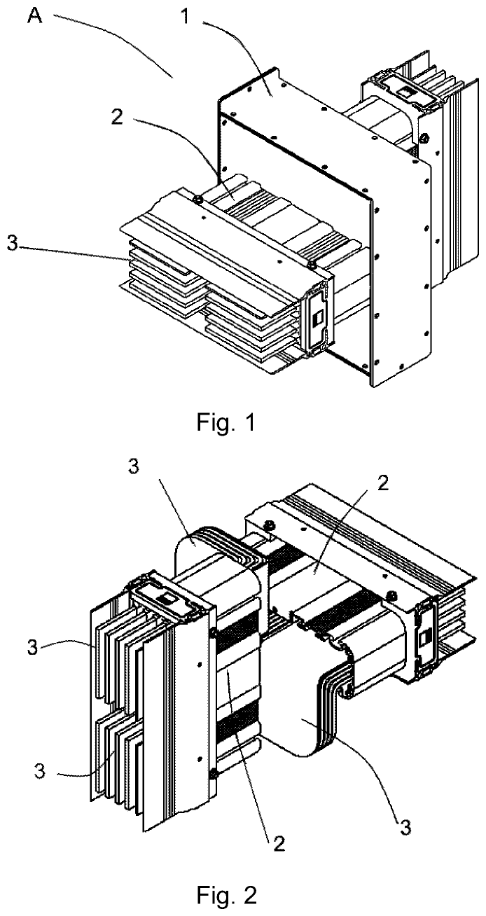

FIG. 2 shows another representative view of the horizontal to on-edge transition module configuration (A), which is the subject of the invention.

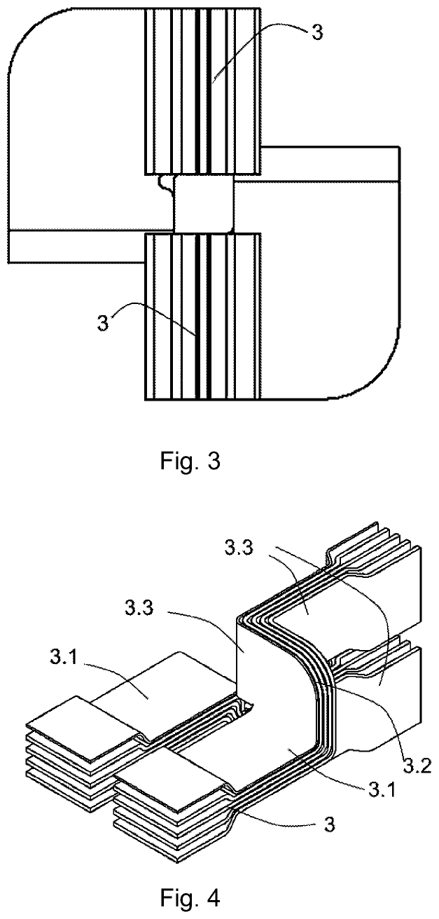

FIG. 3 shows a representative view of the conductor bar (3) from the top in the configuration of the horizontal to on-edge transition module (A), which is the subject of the invention.

FIG. 4 A detailed perspective view of the conductor bar (3) in the configuration of the horizontal to on-edge transition module (A), which is the subject of the invention.

The transition module structure (A), which is the subject of the invention, consists main parts of the conductor bar (3) that provides energy transmission, the body (2) that provides protection and continuity by keeping the said conductor bars (3) together, horizontal conductor (3.1), which is the section where the said conductor bars (3) move in horizontal position, on-edge conductor (3.3), which is the section where the said conductor bar (3) move vertically with the transition from horizontal to vertical, curved corner (3.2), which enables said conductor bar (3) to transition from the horizontal conductor (3.1) state to the on-edge conductor (3.3) state, body ground connection module (1), which provides the transmission of the soil and protects the curved corner (3.2) and horizontal conductor (3.1) and the on-edge conductor (3.3) from external factors, by closing the entrance areas of the horizontal conductor (3.1) combined by the curved corner (3.2)

With the horizontal to on-edge transition module structure (A), which is the subject of the invention, the losses that the conductor bar (3) will experience due to factors such as bolting and transition from surface to surface are prevented.

The dimensions of the said body (2) are reduced to minimum dimensions by reducing the phase gaps of the conductor bars (3), thereby improving the volume. Due to the compactness of the said conductor bars (3), extra voltage drops in the system are prevented.

In addition, a reservoir suitable for resin casting is created in the body ground connection module (1), preventing weight and casting difficulties while serving at IP68 level.

Said conductor bars (3) consist of 3 parts as a single piece. The section that moves in the horizontal position is the horizontal conductor (3.1) section. The section where the aforementioned conductor rods (3) pass from horizontal to vertical and progress vertically is the on-edge conductor (3.3).

The curved corner (3.2) section, which enables the said conductor bars (3) to transition from the horizontal conductor (3.1) state to the on-edge conductor (3.3) state, is positioned as a right angle.

The transition section where the aforementioned horizontal conductor (3.1), on-edge conductor (3.3) and curved corner (3.2) section is located together is closed with the ground connection module (1) and it is protected from external factors.

1. A horizontal to on-edge transition module configuration made to be used in the energy distribution lines containing a conductor bar that provides energy transmission and a body that provides protection and continuity by holding together the said conductor bars, which the electrical transition resistance is minimized, which is created to be used in changes according to the way the line goes and the phase sequence characterized in that, comprises on-edge conductor, which is the section where the said conductor rods move vertically with the transition from horizontal to vertical, a curved corner, which enables said conductor bars to transition from the horizontal conductor state to the on-edge conductor state, a body ground connection module, which provides the transmission of the soil and protects the curved corner and horizontal conductor and the on-edge conductor from external factors, by closing the entrance areas of the horizontal conductor combined by the curved corner.

2. A transition module configuration in accordance with claim 1, wherein said curved corner is a right angle.

3. A transition module structure according to claim 1, wherein said body earth connection module contains a chamber where resin casting is positioned to provide insulation at IP68 level.
